(19) United States
(12) Patent Application Publication
(10) Pub. No.: US 2021/0096295 A1
(43) Pub. Date: Apr. 1, 2021

(54) PANEL LIGHT APPARATUS

(71) Applicant: XIAMEN ECO LIGHTING CO. LTD., Kiamen (CN)

(72) Inventors: Tong Luo, Xiamen (CN); Yongzhe Dong, Xiamen (CN); Lei Zhang, Xiamen (CN)

(21) Appl. No.: 16/715,205

(22) Filed: Dec. 16, 2019

(30) Foreign Application Priority Data
Sep. 27, 2019 (CN) 201921625011.3
Sep. 27, 2019 (CN) 201921626190.2

(51) Int. Cl. F21V 8/00

(52) U.S. Cl. CPC G02B 6/0085; G02B 6/0093; G02B 6/0091

(57) ABSTRACT

A panel light apparatus includes an optical guiding unit, a light source, a support base and a stop unit. The light source emits a original light passing through the optical guiding unit via an entrance side of the optical guiding unit. The stop unit keeps at least a first distance between the entrance side of the optical guiding unit and the light source when the optical guiding unit has a thermal expansion so that the entrance side of the optical guiding unit expands toward the light source.

### FIELD OF INVENTION

The present invention is related to a panel light apparatus and more particularly related to a panel light apparatus with good heat dissipation function.

### BACKGROUND

LED (Light Emitted Diode) is popular today and widely used in various fields to replace traditional light devices. For example, panel light device provides soft light by guiding light from a lighting guide. This makes panel light devices a great tool for providing light to human life while not hurting people eyes or making people not comfortable.

In addition, LED modules may decrease their life spans if being kept working for long time under high working temperature. Therefore, it is beneficial to design panel light and other light device with better heat dissipation features and with longer life span.

### SUMMARY OF INVENTION

According to an embodiment, a panel light apparatus includes an optical guiding unit, a light source, a support base and a stop unit. The light source emits an original light passing through the optical guiding unit via an entrance side of the optical guiding unit. The support base is used for mounting the light source. The stop unit keeps at least a first distance between the entrance side of the optical guiding unit and the light source when the optical guiding unit has a thermal expansion so that the entrance side of the optical guiding unit expands toward the light source.

In some embodiments, the concept mentioned here, e.g. the stop unit and related arrangement, may be used in a light bulb, a light tube, a downlight or some other light devices.

In some embodiments, the optical guiding unit may be a light guiding plate. The light guiding plate may be made of a plastic plate with micro dots formed by applying laser lights.

In some embodiments, the optical guiding unit may include a lens plate, a diffusion plate to change light movement paths. In some other embodiment, the optical guiding unit may be a transparent plate attached with color or fluorescent layers to change light characteristics like colors

In some embodiments, the panel light apparatus may also include a deformable unit pressing the support base to the optical guiding unit.

In some embodiments, the deformable unit has an inner side pressing the support base and has an external side pressing a panel frame of the panel light apparatus.

In some embodiments, the deformable unit has elastic force. When there is no external force applying on the deformable unit, the deformable unit presses the support base to keep the support base fixing at a predetermined position.

In some embodiments, the deformable unit includes a spring.

In some embodiments, the stop unit is fixed on the support base, and when the optical guiding unit expands, the entrance side of the optical guiding unit engages an edge of the stop unit before engaging the light source.

In some embodiments, the stop unit is fixed to the optical guiding unit.

In some embodiments, the support base comprises a light source plate and a heat dissipation structure.

In some embodiments, the stop unit is fixed to the heat dissipation structure.

In some embodiments, the heat dissipation structure has a wall side and a bottom side, the light source plate is placed on the bottom side and pressing the wall side.

In some embodiments, there is a heat dissipation layer between the wall side and the light source plate.

In some embodiments, the stop unit comprises a spring.

In some embodiments, the optical guiding unit is a light guiding plate. The light guiding plate has a lateral side for facing the light source and has a top side attaching to a reflective layer. Light is escaped from the light guiding plate from a bottom side of the light guiding plate.

In some embodiments, the reflective layer has a heat dissipation unit for guiding heat of the optical guiding unit to a heat dissipation structure of the support base.

In some embodiments, the panel light apparatus also includes a diffusion layer heat connected to a panel frame and a heat dissipation structure of the support base.

In some embodiments, the panel light apparatus also includes a groove for the support base to move inside the groove.

In some embodiments, the panel light apparatus also includes a distance sensor. When the first distance between the optical guiding unit and the light source is less than a threshold, a driver controls the light source to lower down an output light of the light source.

In some embodiments, the panel light apparatus also includes a distance sensor. When the first distance between the optical guiding unit and the light source is less than a threshold, a driver controls adjacent LED modules of the light source to turn on and turn off alternatively.

In some embodiments, the light source has a first light source part and a second light source part facing to two sides of the optical guiding unit. A driver turns on and turns off the first light source part and the second light source part alternatively.

In some embodiments, the stop unit has a reflective layer.

The driver mentioned above may include driver circuits for converting an external power source to a direct current supplying to LED modules of the light source.

### BRIEF DESCRIPTION OF DRAWINGS

FIG. 1 illustrates a panel light apparatus.

FIG. 2 is a top view of the panel light apparatus of FIG. 1.

FIG. 3 is a cross-sectional view of the panel light apparatus along the AA direction.

FIG. 4 is an enlarged view of a B portion of the panel light apparatus of FIG. 3.

FIG. 5 is an exploded diagram of the panel light apparatus embodiment.

FIG. 6 is enlarged view of the part C in FIG. 5.

FIG. 7 is an enlarged view of part D in FIG. 5.

FIG. 8 is an assembly diagram of the panel light embodiment of FIG. 5.

FIG. 9 is an enlarged view of the E portion in FIG. 7.

### DETAILED DESCRIPTION

According to an embodiment, a panel light apparatus includes an optical guiding unit, a light source, a support base and a stop unit.

The light source emits an original light passing through the optical guiding unit via an entrance side of the optical guiding unit. The support base is used for mounting the light source. The stop unit keeps at least a first distance between the entrance side of the optical guiding unit and the light source when the optical guiding unit has a thermal expansion so that the entrance side of the optical guiding unit expands toward the light source.

In some embodiments, the concept mentioned here, e.g. the stop unit and related arrangement, may be used in a light bulb, a light tube, a downlight or some other light devices.

In some embodiments, the optical guiding unit may be a light guiding plate. The light guiding plate may be made of a plastic plate with micro dots formed by applying laser lights.

In some embodiments, the optical guiding unit may include a lens plate, a diffusion plate to change light movement paths. In some other embodiment, the optical guiding unit may be a transparent plate attached with color or fluorescent layers to change light characteristics like colors

In some embodiments, the panel light apparatus may also include a deformable unit pressing the support base to the optical guiding unit.

In some embodiments, the deformable unit has an inner side pressing the support base and has an external side pressing a panel frame of the panel light apparatus.

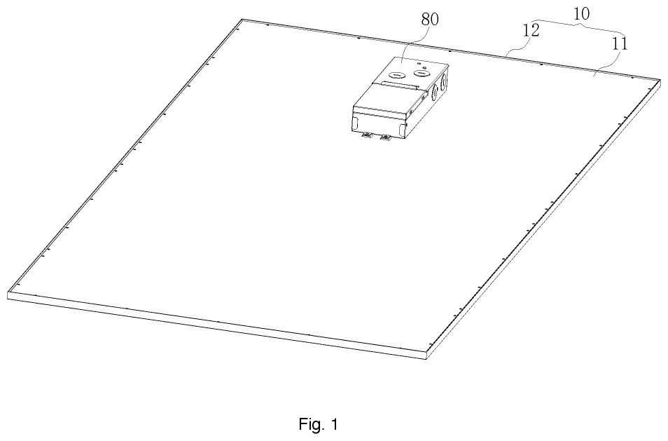

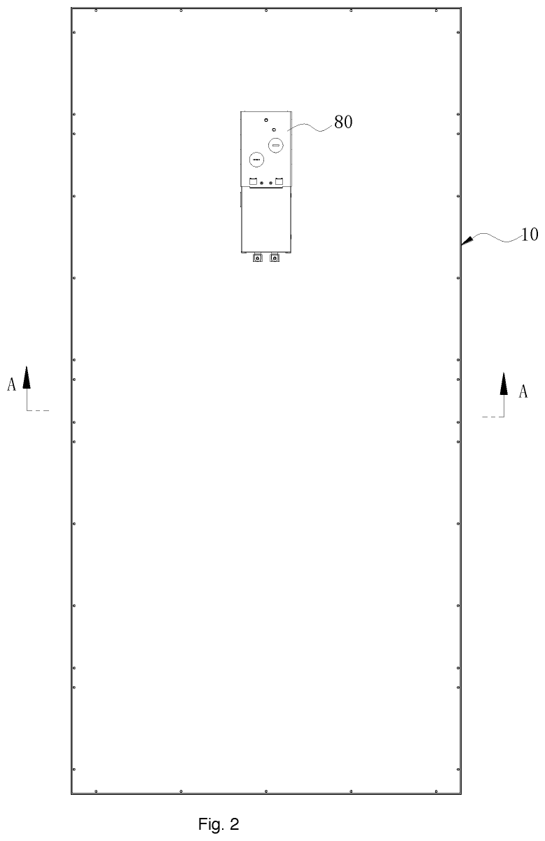

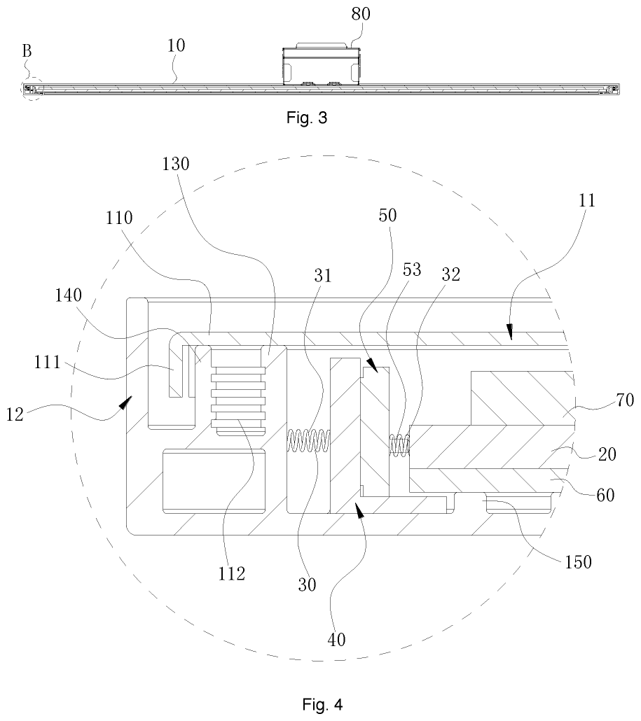

In FIG. 1 to FIG. 4, a panel light embodiment is illustrated. The panel light apparatus includes a housing 10, a deformable unit, a light source 50 and a light guiding plate 20. The light guiding plate 20 is an example of an optical guiding unit mentioned above. The light source 50 may include LED modules and related components and may be implemented with other light components. The deformable unit may be a buffer unit like a sponge block or other elastic component like a spring.

The deformable unit includes a first elastic unit 31 and a second elastic unit 32. The first elastic unit 31 is disposed between an inner side of a panel frame and a back side of the light source 50. The second elastic unit 32 is disposed between a front side of the light source 50 and the light guiding plate 20. The second elastic unit 32 may be regarded as a stop unit mentioned above. In other words, the stop unit may be an elastic or rigid structure. The light source 50 includes a light source plate 51, multiple LED components 52 and at least one stop piece 53. The multiple LED modules 52 are arranged on a front side of the light source plate 51. The stop piece 52, which may be regarded as a stop unit example, is also disposed on the front side of the light source plate 51. The multiple LED modules 52 and the stop piece 53 are disposed at the same side of the light source plate 51. A height of the stop piece 53 is larger than a height of the LED modules 52.

When the light guiding plate 20 is expanded for thermal expansion and engages the second elastic unit 32, the second elastic unit 32 is deformed by the light guiding plate 20, the lateral side of the light guiding plate 20 engages the stop piece 52. The deformation of the first elastic unit 31 is larger than the deformation of the second elastic unit 32.

With such arrangement, the LED modules 52 are not damaged when being pressed by the light guiding plate 20. The first elastic unit 31 and the second elastic unit 32 are both pressed. However, by controlling the elastic deformation, the first elastic unit 31 is easier to be deformed than the second elastic unit 32. With such design, the distance variation between he light guiding plate 20 and the LED modules 52 is reduced compared with just using one elastic unit as the deformable unit as mentioned above.

Such design improves overall optical efficiency. The protection of the LED modules 52 is achieved even when the light guiding plate 20 is not reduced for its dimension.

In the illustrated example, the housing 10 has a flat box shape. The cross-sectional view of the housing 10 has a rectangular shape. The bottom of the housing 10 has an opening and a top of the housing is closed. The housing 10 may be made of aluminum material or other metal material. The light guiding plate 20 may be made of polyester material. The thickness of the light guiding plate 20 is larger than the thickness of the LED modules 52 so that light emitted from the LED modules 52 enters the light guiding plate 20.

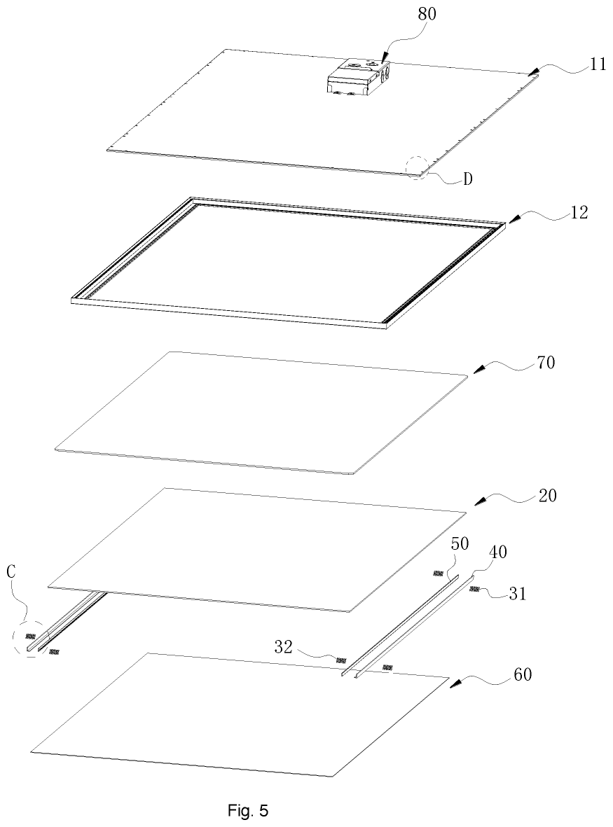

In FIG. 4 and FIG. 5, the panel light apparatus also includes a heat dissipation structure 40. The heat dissipation structure 40 is fixed to a back side of the light source 50. Specifically, the heat dissipation structure 40 is fixed at one side away from the LED modules 52. The first elastic unit 31 is disposed between the heat dissipation structure 40 and an inner side of the housing 10. The heat dissipation structure 40 may engage the housing 10 for enhancing heat dissipation effect and increases a life span of the panel light.

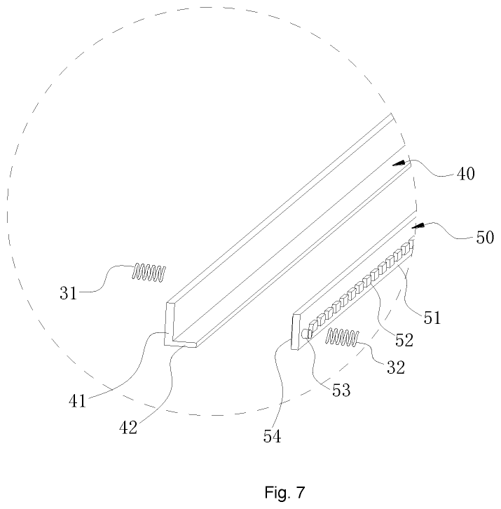

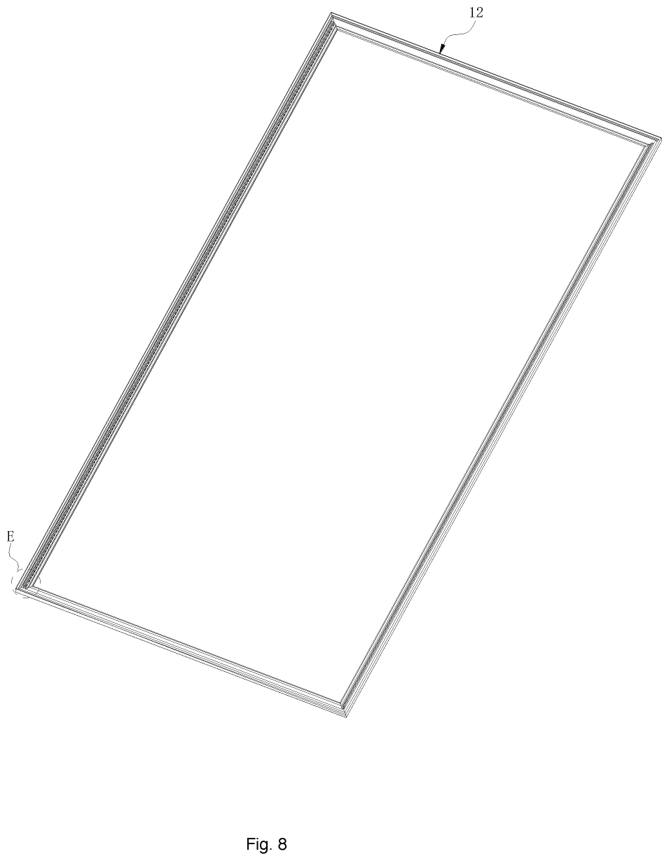

In some embodiments, as shown in FIG. 4, FIG. 5 and FIG. 8, the heat dissipation structure 40 includes an installation plate 41 and a holding plate 42. Specifically, the heat dissipation structure has a L structure. The installation plate 41 is parallel with light emitting direction of the light guiding plate 20. The holding plate 42 supports the light source plate 51. The back side of the light source plate 51 is fixed to the installation plate 41. The first elastic unit 31 is disposed between the installation plate 41 and an inner side of the housing 10. The first elastic unit 31 and the second elastic unit 32 together absorbs the pressure caused by thermal expansion of the light guiding plate 20. In some embodiments, as shown in FIG. 4 and FIG. 7, the backside of the light source plate 51 is attached to the installation plate 41 with a heat dissipation glue. The heat dissipation glue forms a heat dissipation layer 52 between the light source plate 51 and the heat dissipation structure 40. When the light guiding plate 20 is expanded for thermal expansion, the light source 51 moves with the heat dissipation structure 40 within the housing 10.

In some embodiments, the stop piece 53 may be a stop unit formed as an unibody piece with the light source plate 51. There may be multiple stop units on the light source plate 51. For example, there are two stop columns on two sides of the LED modules 52 on the light source plate 51.

In some other embodiments, the first elastic unit 31 and the second elastic unit 32 are made of sponge or polyurethane material. The thickness of the first elastic unit 31 and the second elastic unit 32 may be adjusted by using different layers of deformable materials.

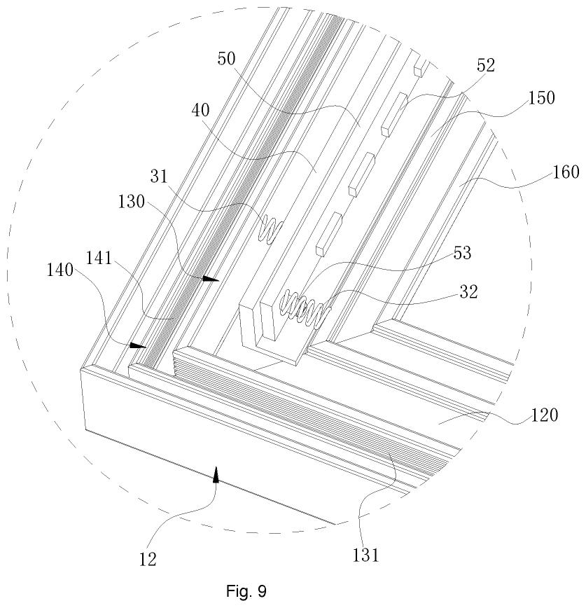

In some other example, the first elastic unit 31 and the second elastic unit 32 may also be spring components, as shown in FIG. 4 and FIG. 9.

In FIG. 4 and FIG. 9, the second spring may be arranged surrounding the stop piece 53 for reducing space so that more space may be reserved for light transmission.

In some embodiments, as shown in FIG. 1, FIG. 4 and FIG. 5, the housing 10 includes a back cover 11 and an outer frame 12. The outer frame 12 has a rectangular shape. The outer frame 12 has a top opening and a bottom opening. The back cover 11 closes the top opening. The back cover 11 and the outer frame 12 together form a container for storing the light guiding plate 20, the light source 50, the heat dissipation structure 40 and the deformable unit.

In some embodiment, as shown in FIG. 4, the panel light may also include a diffusion layer 60 and a reflective layer 70. some heat dissipation structure like metal bars, clips may be placed on the reflective layer 70 for transmitting heat from the light guiding plate to other places like the heat dissipation structure mentioned above. With such design, the heat is further transmitted away to increase the life span of the LED modules.

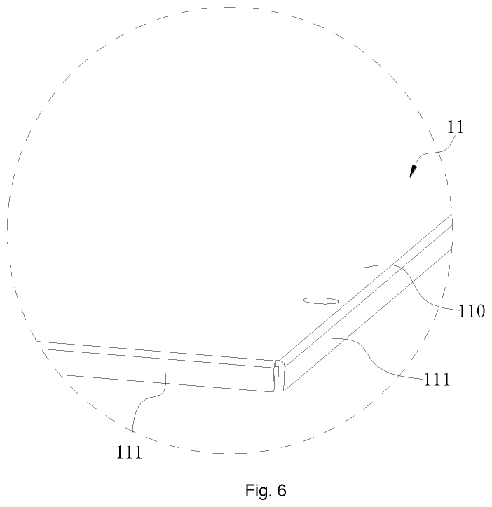

In some embodiments, as shown in FIG. 4, FIG. 6, FIG. 8 and FIG. 9, the outer frame 12 has a support plate 120 formed in its bottom. The support plate 120 has a first inner frame 130 and a second inner frame 140. The second inner frame 140 is between the first inner frame 130 and the outer frame 12. There are screw grooves 131 and 141 in the first inner frame 130 and the second inner frame 140. Such design makes the assembly of the panel light easier.

The diffusion layer 60 has its four peripheral edges pressing the support plate 120 thus the diffusion plate 60, the light guiding plate 20 and the reflective layer 70 are confined in the housing 10. The heat dissipation structure 40 is placed on the support plate 120.

In some embodiment, as shown in FIG. 4 and FIG. 9, the support plate 120 has a protruding limiter 150. The heat dissipation structure 41 may move between the first inner frame 130 and the limiter 150.

In some embodiments, as shown in FIG. 1 to FIG. 3, the panel light also includes a driver (not shown) disposed on a back side of the back cover 11. The driver is connected to the light source 50 electrically. There is a driver box 80 disposed on the back cover 11 with screws. Driver circuits are placed in the driver box 80. Sensor circuit for determining whether the distance between the light guiding plate and the light source may be placed in the driver box 80 while a sensor may be located on the stop unit.

In addition to the above-described embodiments, any modifications, as long as it is within the spirit of the same invention, the various designs that can be made by a person skilled in the art should fall within the scope of the present invention.

1. A panel light apparatus, comprising:
an optical guiding unit;
a light source for emitting a original light passing through the optical guiding unit via an entrance side of the optical guiding unit;
a support base for mounting the light source;
a distance sensor, when the first distance between the optical guiding unit and the light source is less than a threshold, a driver controls the light source to lower down an output light of the light source; and
a stop unit for keeping at least a first distance between the entrance side of the optical guiding unit and the light source when the optical guiding unit has a thermal expansion so that the entrance side of the optical guiding unit expands toward the light source.

2. The panel light apparatus of claim 1, further comprising a deformable unit pressing the support base to the optical guiding unit.

3. The panel light apparatus of claim 2, wherein the deformable unit has an inner side pressing the support base and has an external side pressing a panel frame of the panel light apparatus.

4. The panel light apparatus of claim 2, wherein the deformable unit has elastic force, when there is no external force applying on the deformable unit, the deformable unit presses the support base to keep the support base fixing at a predetermined position.

5. The panel light apparatus of claim 4, wherein the deformable unit comprises a spring.

6. The panel light apparatus of claim 1, wherein the stop unit is fixed on the support base, and when the optical guiding unit expands, the entrance side of the optical guiding unit engages an edge of the stop unit before engaging the light source.

7. The panel light apparatus of claim 1, wherein the stop unit is fixed to the optical guiding unit.

8. The panel light apparatus of claim 1, wherein the support base comprises a light source plate and a heat dissipation structure.

9. The panel light apparatus of claim 8, wherein the stop unit is fixed to the heat dissipation structure.

10. The panel light apparatus of claim 8, wherein the heat dissipation structure has a wall side and a bottom side, the light source plate is placed on the bottom side and pressing the wall side.

11. The panel light apparatus of claim 10, wherein there is a heat dissipation layer between the wall side and the light source plate.

12. The panel light apparatus of claim 1, wherein the LDRS-19-076-US stop unit comprises a spring.

13. The panel light apparatus of claim 1, wherein the optical guiding unit is a light guiding plate, the light guiding plate has a lateral side for facing the light source and has a top side attaching to a reflective layer, light is escaped from the light guiding plate from a bottom side of the light guiding plate.

14. The panel light apparatus of claim 13, wherein the reflective layer has a heat dissipation unit, for guiding heat of the optical guiding unit to a heat dissipation structure of the support base.

15. The panel light apparatus of claim 13, further comprising a diffusion layer heat connected to a panel frame and a heat dissipation structure of the support base.

16. The panel light apparatus of claim 1, further comprising a groove for the support base to move inside the groove.

17. (canceled)

18. The panel light apparatus of claim 1, further comprising a distance sensor, when the first distance between the optical guiding unit and the light source is less than a threshold, a driver controls adjacent LED modules of the light source to turn on and turn off alternatively.

19. The panel light apparatus of claim 1, wherein the light source has a first light source part and a second light source part facing to two sides of the optical guiding unit, and a driver turns on and turns off the first light source part and the second light source part alternatively.

20. The panel light apparatus of claim 1, wherein the stop unit has a reflective layer.
